(19) United States
(12) Patent Application Publication
(10) Pub. No.: US 2015/0113301 A1
(43) Pub. Date: Apr. 23, 2015

(54) CHARGING METHOD AND MOBILE ELECTRONIC DEVICE

(71) Applicants: Qisda (Suzhou) CO., Ltd., Suzhou (CN); Qisda Corporation, Taoyuan (TW)

(72) Inventor: CHIA-CHI WANG, Taipei (TW)

(73) Assignees: Qisda (Suzhou) CO., Ltd., Suzhou (CN); Qisda Corporation, Taoyuan (TW)

(21) Appl. No.: 14/462,585

(22) Filed: Aug. 19, 2014

(30) Foreign Application Priority Data
Oct. 18, 2013 (TW) 102137766

(51) Int. Cl. G06F 1/32; H02J 7/00

(52) U.S. Cl. CPC G06F 1/3234; H02J 7/0052; G06F 1/3287; G06F 1/3206
USPC 713/320

(57) ABSTRACT

The invention discloses a charging method and a mobile electronic device using the charging method. The charging method determines a usage state of the mobile electronic device, selectively disables at least one of software programs or at least one of hardware functions that are operated in a host system of the mobile electronic device or does not to disable the software programs and the hardware functions that are operated in the host system, and charges a rechargeable battery of the mobile electronic device. Thereby, during the charging of the mobile electronic device, the charging method reduces power consumption of the mobile electronic device for shortening the charging time.

### BACKGROUND OF THE INVENTION

1. Field of the Invention

The present invention relates to a charging method, and more particularly, to a charging method used in a mobile electronic device.

2. Description of the Prior Art

The current mobile electronic device, such as the mobile phone or the tablet PC, normally uses rechargeable battery as the power source. When the mobile electronic device runs out of power, we will need to charge or replace the battery. When we shutdown the mobile electronic device to charge the battery, in general there is no power consumption in the mobile electronic device so that the charging time is shortened as much as possible. Based on the normal usage habit of the mobile electronic device, especially the mobile phone, however, for most users the mobile electronic device is never powered off. Therefore when the power is not enough, the mobile electronic device is charged during its power-on status. Since the mobile electronic device is powered on when it is charged, the mobile electronic device keeps consuming power and therefore the charging time is increased. Meanwhile, although the user usually does not mean to operate the mobile electronic device during charging, the mobile electronic device still in the operation status, i.e. the software and the hardware that are executed still keep working. In other words, during charging the mobile electronic device keeps consuming power so as to keep all kinds of service available, including those that the user may not need. Hence, unnecessary power consumption occurs and the burden of charging is increase.

### SUMMARY OF THE INVENTION

Due to the problems stated in the description of the prior art, one purpose of the present invention is to provide a charging method in which during the charging of the mobile electronic device, the services provided by the mobile electronic device are selectively disabled so as to avoid unnecessary power consumption and to shorten the charging time.

According to one embodiment, a charging method applied in a mobile electronic device is provided in this invention. The method comprises: determining a usage status of the mobile electronic device; selectively disabling at least one of software programs or at least one of hardware functions enabled in the mobile electronic device, or not disabling the software programs and the hardware functions enabled in the mobile electronic device, based on the usage status; and charging the mobile electronic device. Therefore, the charging method makes the mobile electronic device decrease power consumption as much as possible during charging so as to decrease the charging time.

According to another embodiment, a mobile electronic device in which the aforementioned charging method is applied is provided in the invention. The mobile electronic device comprises a host system and a rechargeable battery. The host system comprises a processing module and a connection port electrically connected to the processing module. The rechargeable battery is electrically connected to the processing module and provides power to the host system. An external power source can charge the rechargeable battery via the connection port. When the rechargeable battery is charged, the processing module determines a usage status of the mobile electronic device and selectively disables at least one of software programs or at least one of hardware functions enabled in the mobile electronic device, or does not disable the software programs and the hardware functions enabled in the mobile electronic device based on the usage status. Similarly, during charging the mobile electronic device decreases power consumption as much as possible so as to decrease the charging time.

Compared with the prior art, during charging the invention manages the power consumption. In prior art, the power-off of the backlight of the monitor is automatically implemented to save power. In this invention, however, the power consumption management is activated by the charging. Besides, the module disabled in this invention is not limited to the backlight of the monitor, but covers the enabled software programs such as the games and the navigation application, etc., as well as the hardware functions such as the audio circuit and the signal receiving/transmitting circuit, etc. This invention therefore saves energy more effectively during charging.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a mobile electronic device according to an embodiment of the present invention.

FIG. 2 is a main flow chart of a charging method according to the present invention.

FIG. 3 is a flow chart of the charging method according to an embodiment of the present invention.

### DETAILED DESCRIPTION

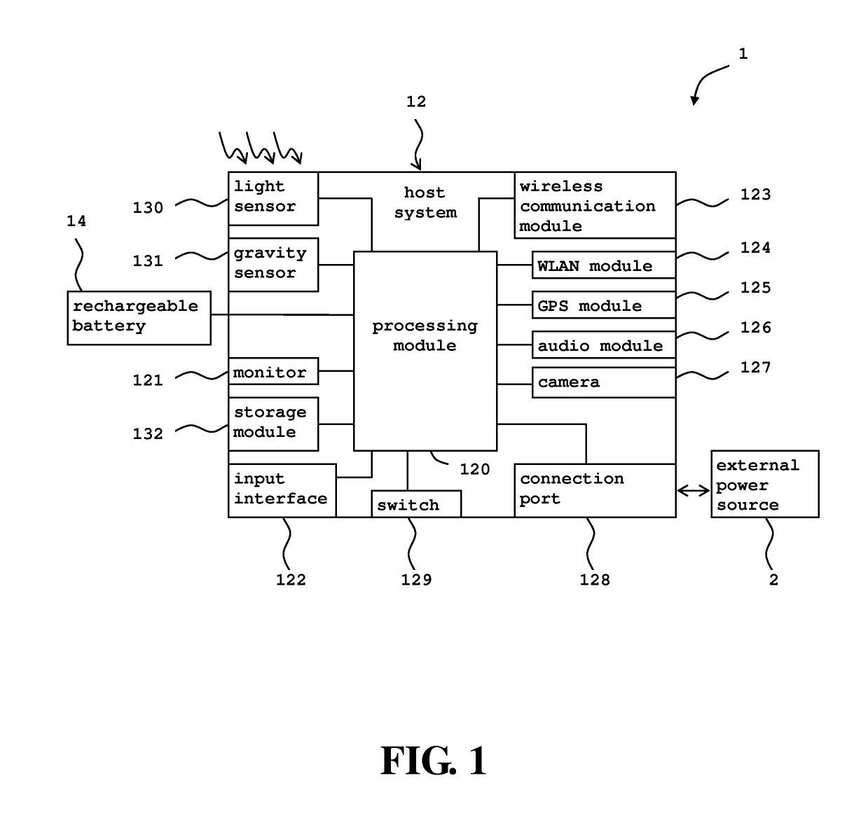

Please refer to FIG. 1. FIG. 1 is a block diagram of a mobile electronic device 1 according to an embodiment of the present invention. The mobile electronic device 1 may cover not limited to a mobile phone, a tablet PC and a PDA, etc. The mobile electronic device 1 comprises a host system 12 and a rechargeable battery 14 electrically connected to the host system 12. The rechargeable battery 14 provides power to the host system 12. The host system 12 comprises a processing module 120, a monitor 121, an input interface 122, a wireless communication module 123, a wireless local area network (WLAN) module 124, a GPS module 125, an audio module 126, a camera 127, a connection port 128, a switch 129, alight sensor 130, a gravity sensor 131 and a storage module 132. The monitor 121, the input interface 122, the wireless communication module 123, the WLAN module 124, the GPS module 125, the audio module 126, the camera 127, the connection port 128, the switch 129, the light sensor 130, the gravity sensor 131 and the storage module 132 are electrically connected to the processing module 120, respectively. The monitor 121 displays images. The input interface 122 enables a user to input information to the mobile electronic device 1. In practical application, the input interface 122 may be a practical key, a keyboard or a touch panel which may be integrated with the monitor 121. The wireless communication module 123, the audio module 126 (comprising a microphone and a speaker) and the camera 127 enable the user to communicate with others via audio and image communication. The WLAN module 124 provides the service of connection to the internet, such as through Wi-Fi equipment. The GPS module 125 receives the GPS satellite signals for positioning. For example, the map software and the navigation software need such positioning information to operate well. The processing module 120 may electrically connected to the rechargeable battery 14. The rechargeable battery 14 may be charged by an external power source 2, such as the supply mains or the mobile power bank, through the connection port 128. The switch 129 is exposed on the outside the enclosure of the mobile electronic device 1, and may be activated by a user, such as when the user presses a power button to generate an activation signal to the processing module 120. The light sensor 130 is exposed outside the enclosure of the mobile electronic device 1 so as to sense the environmental light around the mobile electronic device 1. The gravity sensor 131 determines the installation direction of the mobile electronic device 1 by the gravity sensing. The storage module 132 stores data, such as the source codes of the software programs and the data required for the operation of the hardware functions.

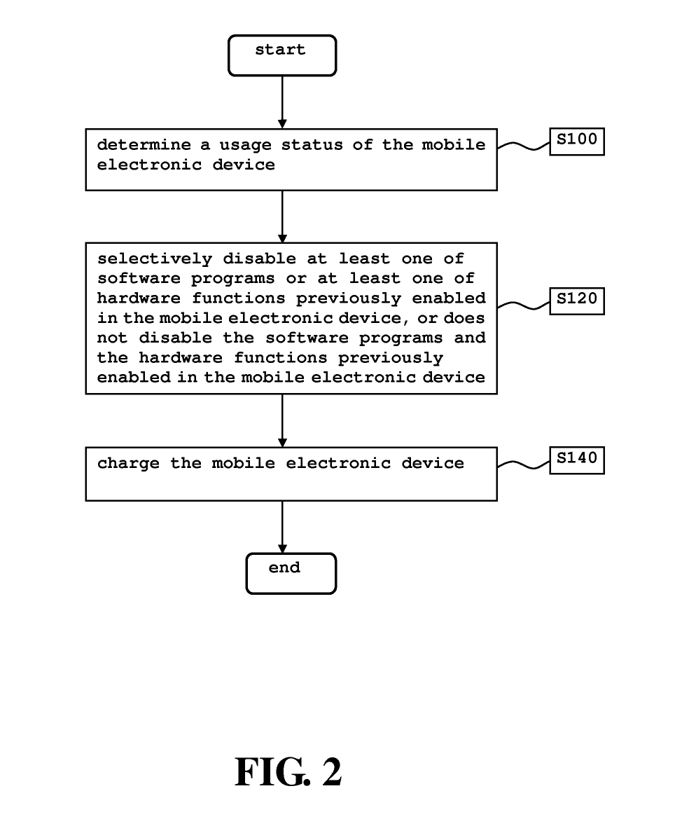

Please refer to FIG. 2. FIG. 2 is a main flow chart of a charging method according to the present invention. Take the mobile electronic device 1 for example. When the rechargeable battery 14 of the mobile electronic device 1 needs to be charged, the charging method determines a usage status of the mobile electronic device 1, as shown in the step S100. Then the charging method selectively disables at least one of software programs or at least one of hardware functions previously enabled in the mobile electronic device 1, or does not disable the software programs and the hardware functions previously enabled in the mobile electronic device 1, based on the usage status, as shown in the step 120. In other words, the charging method may either disable some of the software programs and the hardware functions enabled in the mobile electronic device 1, or just keep those software programs and the hardware functions being enabled, based on the usage status. Through aforementioned two steps, the charging method decreases unnecessary power consumption of the mobile electronic device 1 during its charging. For example, based on the usage status, the charging method determines the software programs and the hardware functions that the user would not use, and then disabled them while charging. Under the situation that the power consumption of the mobile electronic device 1 is properly decreased, the rechargeable battery 14 of the mobile electronic device 1 is charged, as shown in the step 140. Thus, compared with the charging method in the prior art, in the charging method of the invention the charging time of the mobile electronic device 1 is shortened. Both power saving and the charging time decreasing are achieved.

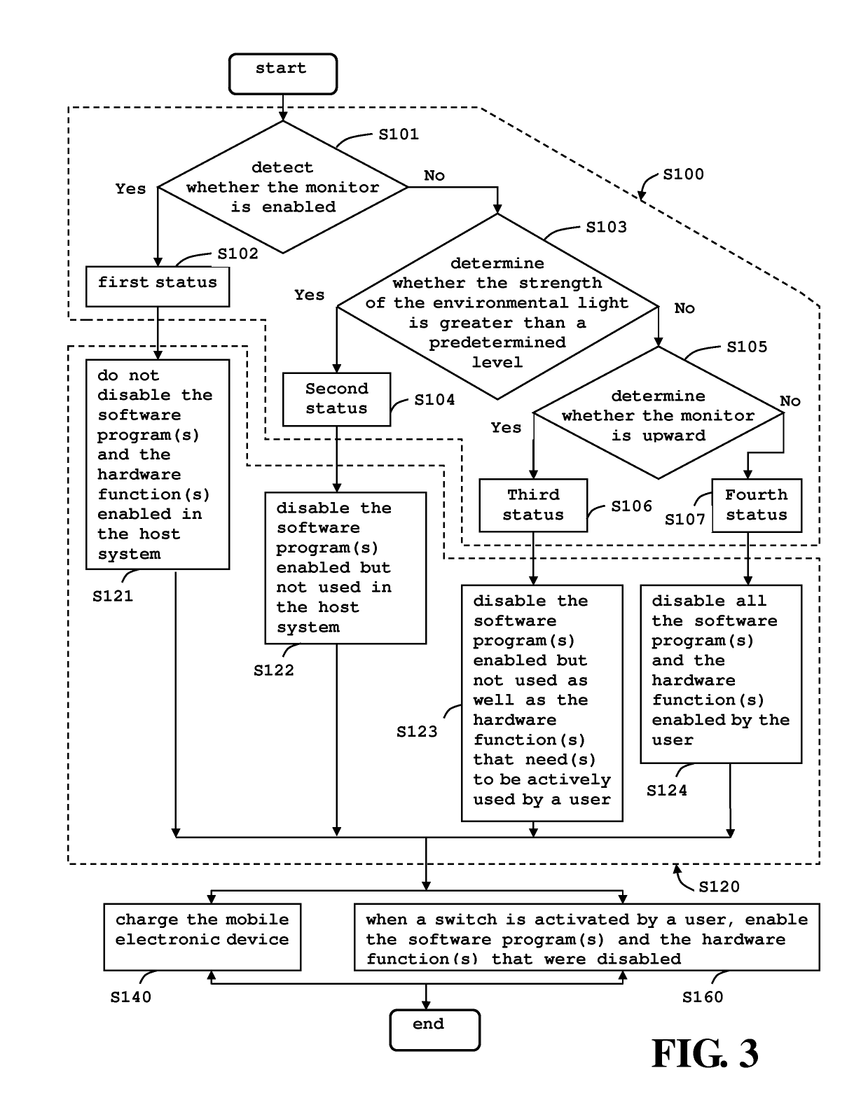

Please refer to FIG. 3. FIG. 3 is a flow chart of the charging method according to an embodiment of the present invention. In this flowchart the construction of the mobile electronic device 1 is taken for example, but the invention is not so limited. In the embodiment, the charging method is applied in the mobile electronic device 1. When the rechargeable battery 14 of the mobile electronic device 1 is ready to be charged, based on the charging method shown in FIG. 3, the processing module 120 detects whether the monitor 121 is enabled, as shown in the step S101. If the processing module 120 detects that the monitor 121 is enabled, the usage status of the mobile electronic device 1 is defined as a first status, as shown in the step S102. In practical application, the first status is regarded as that when the user is using the mobile electronic device 1, including the situation that the mobile electronic device 1 is not being used at the current moment but within a short period of time, such as during the power saving mode of the monitor 121, the mobile electronic device 1 may be used. In practical application, under the first status in the mobile electronic device 1, the navigation software and/or the map software may work with the GPS module 125; the internet may be browsed with the WLAN module 124; the audio and/or the image communication may work with the wireless communication module 123, the audio module 126 and the camera 127; the document editing software and the games, etc. may also be operated. The processing module 120 does not disable the software programs and the hardware functions enabled in the host system 12 based on the first status, as shown in the step S121. Aforementioned software programs and the hardware functions therefore are kept operating under this circumstance.

In the step S101, if the processing module 120 detects that the monitor 121 is disabled, the processing module 120 further detects a strength of an environmental light around the mobile electronic device 1 by the light sensor 130 and determines whether the strength of the environmental light is greater than a predetermined level, as shown in the step S103. The predetermined level can be determined based on the product settings or trials, and is not described in details herein. Generally, when the strength of the environmental light is greater than the predetermined level, it is determined that it is proper for the user to operate the mobile electronic device 1 under that environment. If the processing module 120 determines that the strength of the environmental light is greater than the predetermined level, the usage status of the mobile electronic device 1 is defined as a second status, as shown in the step S104. In practical application, the second status is regarded as that when the user does not use the mobile electronic device 1, such as when the mobile electronic device 1 is put near the user, say on the desk, for a period of time which is longer than the monitor 121 is triggered to enter the power saving mode so that the monitor 121 is disabled, but it is expected that the user may use the mobile electronic device 1 at any time. The processing module 120 disables the software program(s) enabled but not used in the mobile electronic device 1 based on the second status, as shown in the step S122. For example, the navigation software and/or the map software, the internet browser, the document editing software and the games which need the monitor 121 as the operation interface are disabled under this circumstance. Please note that the main function of the video playing software is to play a video, and therefore the video playing software is disabled as well, but the invention is not so limited. For example, the audio playing function of the video playing software may still be kept enabling.

In the step S103, if the processing module 120 determines that the strength of the environmental light is not greater than the predetermined level, i.e. it is dark in the environment, the processing module 120 further determines whether the monitor 121 is upward by the gravity sensor 131, as shown in the step S105. If the processing module 120 determines that the monitor 121 is upward, i.e. the monitor 121 is viewable by the user, the usage status is defined as a third status, as shown in the step S106. In practical application, the third status is regarded as when the user generally doe not operate the mobile electronic device 1 very often. For example, the mobile electronic device 1 is put on the table near the bed and the monitor 121 is upward. The processing module 120 then disables the software program(s) enabled but not used as well as the hardware function(s) that need(s) to be actively used by a user in the host system 12 based on the third status, as shown in the step S123. For example, the navigation software, the map software, the internet browser, the document editing software and the games which need the monitor 121 as the operation interface as well as the GPS module 125 and the WLAN module 124, etc. which need to be actively used by a user are disabled under this circumstance. Please note that the main function of the video playing software is to play a video, and therefore the video playing software is disabled as well, but the invention is not so limited. For example, the audio playing function of the video playing software may still be kept enabling.

In the step S105, if the processing module 120 determines that the monitor is downward, the usage status is defined as a fourth status, as shown in the step S107. In practical application, the fourth status is regarded as when the user in general does not intend to use the mobile electronic device 1. For example, the user takes a rest or falls asleep. The processing module 120 disables all the software program(s) and the hardware function(s) enabled by the user in the host system 12 based on the fourth status, as shown in the step S124. Since the user does not actively use the mobile electronic device 1, the software program(s) and the hardware function(s) enabled by the user need not be kept enabling. Generally speaking, under the fourth status, the processing module 120 may keep enabling only the wireless communication module 123, and disables the others. At this time, the mobile electronic device 1 only has the function of audio communication and the alarm clock as a traditional cell phone. In practical application, the message receiving function may also be kept enabling. In this circumstance, the mobile electronic device 1 can save power to the greatest extent.

As shown in the step S140 of FIG. 3, in the charging method the mobile electronic device 1, or more precisely the rechargeable battery 14, is then charged through the connection port 128 by the external power source 2. Despite that, in the charging method some power consumption is saved in the mobile electronic device 1 based on the usage status of the mobile electronic device 1 as previously described, the software program(s) and the hardware function(s) disabled during the charging may be actively enabled again by the user. Thus, in practical application, in the charging method when a switch 129 is activated by a user, the processing module 120 enables the software program(s) and the hardware function(s) that were previously disabled, as shown in the step 160.

Please note that in this embodiment, the step of charging the rechargeable battery 14 is implemented after the usage status of the mobile electronic device 1 is determined, but this invention is not so limited. For example, once the processing module 120 detects that the external power source 2 is connected to the connection port 128, the rechargeable battery 14 can be charged, and the processing module 120 determines the usage status of the mobile electronic device 1 at the same time, and the power saving steps as described in the steps from S121 to S124 are then implemented. Moreover, in the embodiment, the step of determining the usage status of the mobile electronic device 1 is implemented one time as described in the steps from S101 to S107, but the invention is not so limited. Based on the practical application, for example, during charging, after the user operates the mobile electronic device 1 which is in the second or other status, the charging method may determines the usage status of the mobile electronic device 1 again as described in the steps from S101 to S107 and then implements the power saving steps as described in the steps from S121 to S124. By this method, the mobile electronic device 1 operates with the power consumption as less as possible during charging. Besides, in this embodiment, there are four usage statuses for the mobile electronic device 1, but the invention is not so limited. In practical application, one can increase or decrease the numbers of the usage status as well as the corresponding determining steps based on the specification of the mobile electronic device 1.

Those skilled in the art will readily observe that numerous modifications and alterations of the device and method may be made while retaining the teachings of the invention.

What is claimed is:

1. A charging method applied in a mobile electronic device, the method comprising:
(a) determining a usage status of the mobile electronic device;
(b) selectively disabling at least one of software programs or at least one of hardware functions enabled in the mobile electronic device, or not disabling the software programs and the hardware functions enabled in the mobile electronic device, based on the usage status; and
(c) charging the mobile electronic device.

2. The charging method of claim 1, wherein the mobile electronic device comprises a monitor, the step (a) comprising:
(a1) detecting whether the monitor is enabled; and
(a2) when detecting that the monitor is enabled in the step (a1),
the usage status is defined as a first status;
wherein during the step (b), when the usage status is the first status, the software program(s) and the hardware function(s) enabled in the mobile electronic device is/are not disabled.

3. The charging method of claim 2, wherein the mobile electronic device comprises a light sensor, the step (a) comprising:
(a3) if the step (a1) detects that the monitor is disabled, detecting a strength of an environmental light around the mobile electronic device by the light sensor and determining whether the strength of the environmental light is greater than a predetermined level; and
(a4) if the step (a3) determines that the strength of the environmental light is greater than the predetermined level, defining the usage status as a second status;
Wherein during the step (b), when the usage status is the second status, the software program(s) enabled but not used in the mobile electronic device is/are disabled.

4. The charging method of claim 3, wherein the mobile electronic device comprises a gravity sensor, the step (a) comprising:
(a5) if the step (a3) determines that the strength of the environmental light is not greater than the predetermined level, determining whether the monitor is upward by the gravity sensor; and
(a6) if the step (a5) determines that the monitor is upward, defining the usage status as a third status;
wherein during the step (b), when the usage status is the third status, the software program(s) enabled but not used as well as the hardware function(s) that need(s) to be actively used by a user in the mobile electronic device are disabled.

5. The charging method of claim 4, the step (a) comprising:
(a6) if the step (a5) determines that the monitor is downward, defining the usage status as a fourth status;
Wherein during the step (b), when the usage status is the fourth status, all the software program(s) and the hardware function(s) enabled by the user are disabled.

6. The charging method of claim 5, wherein the mobile electronic device comprises a wireless communication module and an audio module, during the step (b) when the usage status is the fourth status, only the wireless communication module in the mobile electronic device is kept being enabled.

7. The charging method of claim 1, wherein the mobile electronic device comprises a switch, the method comprising:
(d) when the switch is activated by a user, enabling the software program(s) and the hardware function(s) that were disabled.

8. A mobile electronic device comprising:
a host system, comprising a processing module and a connection port electrically connected to the processing module; and
a rechargeable battery, electrically connected to the processing module and providing power to the host system, and an external power source charging the rechargeable battery via the connection port,
wherein when the rechargeable battery is charged, the processing module determines a usage status of the mobile electronic device and selectively disables at least one of software programs or at least one of hardware functions enabled in the mobile electronic device, or does not disable the software programs and the hardware functions enabled in the mobile electronic device based on the usage status.

9. The mobile electronic device of claim 8, wherein the host system comprises a monitor electrically connected to the processing module, when the rechargeable battery is charged, the processing module detects whether the monitor is enabled, and when the processing module detects that the monitor is enabled, the usage status is defined as a first status and the processing module does not disable the software program(s) and the hardware function(s) enabled in the mobile electronic device based on the first usage status.

10. The mobile electronic device of claim 9, wherein the host system comprises a light sensor electrically connected to the processing module, when the rechargeable battery is charge, if the processing module detects that the monitor is disabled, the processing module detects a strength of an environmental light around the mobile electronic device by the light sensor and determines whether the strength of the environmental light is greater than a predetermined level, and when the processing module determines that the strength of the environmental light is greater than the predetermined level, the usage status is defined as a second status and the processing module disables the software program(s) enabled but not used in the mobile electronic device based on the second status.

11. The mobile electronic device of claim 10, wherein the host system comprises a gravity sensor electrically connected to the processing module, when the rechargeable battery is charged, if the processing module detects that the monitor is disabled and that the strength of the environmental light is not greater than the predetermined level, the processing module further determines whether the monitor is upward by the gravity sensor, and if the processing module determines that the monitor is upward, the usage status is defined as a third status and the processing module disables the software program(s) enabled but not used as well as the hardware function(s) that need(s) to be actively used by a user in the host system based on the third status.

12. The mobile electronic device of claim 11, wherein if the processing module determines that the monitor is disabled, that the strength of the environmental light is not greater than the predetermined level, and that that the monitor is downward, the usage status is defined as a fourth status and the processing module disables all the software program(s) and the hardware function(s) enabled by the user in the host system based on the fourth status.

13. The mobile electronic device of claim 12, wherein the host system comprises a wireless communication module and a audio module both of which are electrically connected to the processing module, and when the usage status is the fourth status, the processing module keeps enabling only the wireless communication module in the host system.

14. The mobile electronic device of claim 8, wherein the host system comprises a switch electrically connected to the processing module, and when the switch is activated by a user, the processing module enables the software program(s) and the hardware function(s) that was/were disabled.
